(19) United States
(12) Patent Application Publication
(10) Pub. No.: US 2015/0321089 A1
(43) Pub. Date: Nov. 12, 2015

(54) A NOVEL TOY CONSOLE AND METHODS OF USE

(71) Applicant: SEEBO INTERACTIVE LTD., Tel Aviv (IL)

(72) Inventors: Lior AKAVIA, Tel Aviv (IL); Liran AKAVIA, Tel Aviv (IL); Ido KLEINMAN, Tel Aviv (IL); Lior KENAN, Tel Aviv (IL)

(73) Assignee: SEEBO INTERACTIVE LTD., Tel Aviv (IL)

(21) Appl. No.: 14/651,863

(22) PCT Filed: Dec. 12, 2013
(86) PCT No.: PCT/IL2013/051028

§ 371 Date: Jun. 12, 2015

Related U.S. Application Data
(60) Provisional application No. 61/767,526, filed on Feb. 21, 2013.
(60) Provisional application No. 61/736,604, filed on Dec. 13, 2012.

(51) Int. Cl. A63F 13/235; A63F 13/69

(52) U.S. Cl. CPC A63F 13/235; A63F 13/69

(57) ABSTRACT

The invention is directed to a novel detachable toy console usable as a control unit for multiple connected toy systems, said toy console is configured and operable to connect interchangeably with at least one smart device and to be attached to a console ready toy and detached from it, to thereby allow a user to use the toy console with another console ready toy, said toy console comprising: a MCU; a communication module for establishing connection with at least one smart device; an external connector for attaching and detaching the toy console to the console ready toy; and a power source. The toy console may further comprise a motion sensor and be used as a wearable toy console. The invention is also directed to A wearable toy console usable as a control unit for multiple connected toy systems, configured and operable to connect interchangeably with at least one smart device and to be carried by a toy and/or by a wearable accessory on the hand of a user, wherein the wearable toy console is configured to be passed by the user from one toy to another or to the hand wearable accessory to thereby allow the usage of the toy console with multiple toys.

### FIELD OF THE INVENTION

The present invention is directed to a novel toy console configured and operable to communicate with a smart device. The novel toy console is further configured to be electrically attached and detached to a console ready toy via a dedicated toy module, and it may further mechanically be connected to a pseudo connected toy.

### BACKGROUND

Toys, games, playing systems and other similar entertainment and educational systems are well known for providing entertainment opportunities as well as valuable learning to children and adults. In the new era when smart devices become integral part of our life, it seems that the possibilities of bringing fun and excitement as well as education and learning through games and toys are limitless and the options to challenge children's imaginations and to encourage creativity and social interactivity are infinite.

Although enormous number of games and toys are available in the market, most of them offer only a primitive engaging play experience, and thus, there is a need for more exciting and entertaining games and toys that will increase learning and entertainment opportunities for children and stimulate creativity and imagination.

Some toy companies have already understood the potential of connected toys, and started developing their own version of these toys. Examples of such toys are: “Apptivity Barnyard” by Fisher Price, animals play set that is also being used as a case for iPad, wherein thee figures can be placed on the iPad for connectivity (http://www.amazon.com/Fisher-Price-Little-Apptivity-Barnyard-Playset/dp/B00DEG6WG8). Another example is the toys line of AppToyz (http:www.apptoyz.com/shop/appdrive/).

Both examples illustrate the need for this kind of interactivity. However, the main issue with these toys still remains the cost of electronic component in the toy, as well as the lack in flexibility (all the toys above suit only one size and type of smart device, e.g. iPad).

In addition, most of the small-medium toy companies in the market have no ability to make the required adjustments with ease, in order to develop a connected toy, there's a need to implement hardware, firmware and software as an integral part of the toy, which is by itself, a very complex and expensive process. This causes a raise in the toys' retail price to a non-affordable one.

In addition, the excessive usage of electrical components in general due to the accelerated technological developments including in the toys industry, contributes to environmental pollution, thus, a solution that allows minimizing the usage of electric units is required.

The present invention is aimed to provide a novel toy console that is functionally configured and operable to serve as an independent control unit i.e. to serve as the “brain”, the core element of connected interactive toy systems that will provide the user a creative and multi-optional playing experience. In accordance with one aspect of the invention, the novel toy console is a detachable unit, configured to be attached and detached from the a console ready toy (CRT) having a complementary toy module according to the user/users preferences, thus, reducing the need for having a control unit in every single toy system and saving undesired waste of electrical components. Thus, reducing significantly the cost of the toy itself (since the novel toy console which contains the electrical components is purchased only once for a limitless amount of supported toys).

In accordance with one another aspect of the invention, the novel toy console is configured to be carried by the user together with a wearable accessory such as a glove or a bracelet or to be carried by the user together with a pseudo connected toy.

### SUMMARY OF THE INVENTION

It is the aim of the present invention to provide a novel detachable toy console that functionally serves as a core element in connected toy systems for entertainment and learning purposes.

The novel toy console provided herein (also referred hereinafter as: “detachable control unit”, “detachable toy console”, and “control unit” interchangeably) is configured to be electrically attached and detached from any compatible toy i.e., any “Console Ready Toy” (CRT) comprising a complementary toy module, thus reducing the need for having a control unit in every single toy system and saving undesired waste of electrical components and money.

According to one aspect of the invention, the novel detachable toy console is configured and operable to be connected to a complementary toy module that is embedded within a CRT and configured and operable to connect to the toy console and to transfer data and commands to and from the CRT (toy platform) to the toy console and vice versa. The toy console is further configured and operable to transfer data and commands to and from a smart device connected to the toy console either by wires or wirelessly.

For simplicity of the description, the complementary toy module will be denoted hereinafter as: “toy module”, however it should be clear that the same module may be used in other systems as well such as learning/tutoring system. The unique toy console (control unit) of the invention is configured to be detached from one toy platform and to be attached to another toy platform according to the user preferences, thus, allowing a large variety of playing modules in one system, and further allowing a substantial economy in money and in electric components thereby contributes to a greener environment.

The CRT may be a plane two dimensional shape like a Monopoly board or a chess board. Alternatively CRT may be configured in a three dimensional landscape structure such as, but not limited to a jungle, a savanna, a field, an island, a battlefield, a garden etc. Alternatively CRT may be configured in a three dimensional structure like, but not limited to, a kitchen, a working tool desk, a doll house, a farm, a castle, a pirate ship, a car racing track, a doll, an animal, a robot, and the like.

The term “connected toy system” as used herein refers to a playing system comprising at least a toy console configured to function as the “brain” of the system and responsible for connection and communication with a smart device, and a toy platform, wherein the toy system have the ability to interchangeably connect with smart devices including without limitation smart phones, tablets, TVs, smart TVs, PCs, gamming consoles and micro consoles. A detailed description of exemplary connected toy systems is provided in WO PCT/IL2012/000302 of the same inventors, incorporated herein by reference. Although the toy console is mostly used for connection and communication, it is also configured to make some local computations. For example, the CRT can make a simple reaction when connected to the toy console, even if the toy console is not connected to a smart device. Additionally, the toy console may be configured to make computations on the data before sending it to the smart device, or after receiving it from the smart device.

Also, two or more consoles may have the ability to communicate with each other even when a smart device is not in their surroundings.

The term “toy platform” as used herein refers to a toy configured and operable to be used in a connected toy system. The toy platform may contain two main types of toys:

Toy type A: a pseudo connected toy. This toy is a non-electric toy and has no sensors and buttons positioned on it or attached to it. Toy type A may have a pocket or a groove as part of its structure and/or accessories configured to hold the toy console within it. In such variation, the player may simply hold the toy with the console within it and play in front of the smart device. In such variation the toy is a pseudo connected toy as the motion and signals received by the smart device is obtained from the toy console and not from the toy platform holding the toy console. Similarly, the pseudo connected toy itself may be wearable; for example, the toy is a theater doll character that the user wears on his/her hand and the toy console is carried by the doll in a pocket or another accessory positioned on the doll. In such variation, the toy console is configured to be connected only with the smart device. A pseudo connected toy may also be used with a “wearable” toy console, i.e. a wearable accessory such as a glove or a bracelet that the toy console is inserted into it in a dedicated pocket or groove. In such embodiment the user “wears” the toy console and holds the pseudo connected toy in his/her hand and every movement that the user performs with its hand is being referred to the toy although the signal is obtained from the wearable console. Additionally, the pseudo toy may be mechanically attached to the wearable toy console via mechanical means such as a Velcro, connecting strip, magnets, belt, sticky materials, and the like.

Toy type B: a console ready toy (CRT). This toy is an electric toy, i.e., a toy having the ability to be electrically connected with the toy console. The connection is obtained by an interfacing with a complementary toy module implanted in the CRT. The CRT further comprises sensors and/or buttons attached to it. In such variation, additional playing accessories such as detachable toy elements in various shapes and characters may be attached to the toy via sensors as will be described in details with reference to the figures below. In such variation of the invention, data created on the toy platform is processed by the toy console and displayed by using a suitable proprietary app on the smart device. In addition, data created or obtained by the smart device may be delivered via the toy console to the toy platform to thereby create a signal on the toy platform (e.g. a led is lightened, a buzz is heard, a movement is created, and the like.

In accordance with embodiments of the present invention, the detachable toy console may be used as a stationary element. Alternatively, the toy console may be a portable element configured to be carried together with the CRT when connected. The toy console is configured to be detached from one CRT and to be attached to another CRT according to the user preferences as will be described in details below. The toys console may have many different shapes and designs: square, circle, heart, diamond, and others. The console can also have different battery type: AA, AAA, CR2032, and others.

The CRT may be a static toy such as a doll house, a castle, a farm and the like. Alternatively, the CRT may be a mobile toy such as a pirate ship, an airplane, a dragon, and the like. The connection of the CRT to the toy console via the toy module is established by a dedicated connector configured to provide electrical and mechanical attachment of the two elements. The communication between the toy console and the toy module may be established in various configurations and modes. Some examples of such communication modes are provided with reference to the figures below. The connector physically attaches the toy console and the toy via the connector's pins and complementary socket. The connection between the two elements may further be strength by additional lock, so as to fasten the holding between the two components upon usage. This can be useful when the toy console comprises accelerometer sensor or any other motion sensor, and the CRT is a mobile toy that may be used by the player on a surface and on air as well, for example a pirate ship that the user plays with the detachable toy pirates on a surface and when the player desire to simulate sailing he may hold the ship in his hand and every movement he performs is processed and/or displayed on the smart device.

The novel toy console provided herein is functionally adapted to serve as a processor embedded unit that upon attachment to a toy module allows the module communication capabilities that further enhances the ability to output feedback to the user either through the toy module or through the smart device or both. The feedback output types produced may be without limitation, audio, visual and mechanical.

### BRIEF DESCRIPTION OF THE DRAWINGS

Examples illustrative of embodiments of the disclosure are described below with reference to figures attached hereto. In the figures, identical structures, elements or parts that appear in more than one figure are generally labeled with the same numeral in all the figures in which they appear. Dimensions of components and features shown in the figures are generally chosen for convenience and clarity of presentation and are not necessarily shown to scale. Many of the figures presented are in the form of schematic illustrations and, as such, certain elements may be drawn greatly simplified or not-to-scale, for illustrative clarity. The figures are not intended to be production drawings.

The figures (Figs.) are listed below.

FIGS. 1A-1B are schematic block diagram illustrations of two operation mode variations of a toy console configured and operable to be electrically and mechanically connected to a CRT via a complementary toy module and further to be connected to a smart device either wirelessly or via cable respectively, in a connected toy system, wherein the CRT comprises sensors connected to the toy module.

FIG. 2 is a schematic block diagram illustration of another variation of optional connection between a toy console, a CRT having a complementary toy module, and a smart device, in a connected toy system, wherein the CRT comprises sensors connected to the toy module and wherein, recognition of the toy module by the toy console is obtained by a serial memory.

FIG. 3 is a schematic block diagram illustration of one another variation of a toy console and a CRT having a complementary toy module, in a connected toy system comprising a smart device connected wirelessly to the toy console, and a toy platform containing sensors connected to the toy module, wherein the toy module comprises elements configured to allow enlargement of the number of ports available to the processor of the toy console.

FIG. 4 is a flowchart illustration of two exemplifying operation modes of a connected toy system comprising the toy console and the CRT having a toy module embedded in it as illustrated in FIGS. 1 and 2, in accordance with variations of the invention.

FIG. 5 is a schematic illustration of a tag sensing circuit demonstrating sensing of a tag mated with a hotspot in a specific play platform by a toy console connected to a toy module.

FIG. 6 that schematic illustrates another example of a connected toy system with a toy console, a CRT, and a smart device.

FIG. 7 is a schematic illustration of a detachable Toy console connected to a CRT that is shaped as a pirate ship, wherein the board of the ship functions as a recognition surface that allows recognition of detachable toy elements by various means.

FIG. 8 is a schematic illustration of a toy console configured and operable to be connected with a smart device in a connected toy system, wherein the toy platform is a pseudo connected toy.

FIGS. 9A-9D are schematic illustrations of a pseudo connected (non-electric) toy wherein, FIG. 9A illustrates a toy having a special pocket configured to hold the toy console; FIG. 9B illustrates a toy having a Velcro on it for attaching the toy console; and FIG. 9C illustrates a toy having a Velcro configured to attach the toy to a glove having a special pocket for holding the toy console.

FIGS. 10A-10C illustrate some examples of wearable toy consoles wherein, FIGS. 10A and 10B illustrate gloves and FIG. 10C illustrates a bracelet having a dedicated pocket for holding the toy console.

FIG. 11 schematically illustration of a wearable toy console positioned within dedicated pockets in a glove and a pseudo connected toy.

FIG. 12 is a flow chart illustrating dynamic assets loading for a connected toy mobile application.

### DESCRIPTION OF VARIATIONS OF THE INVENTION

In the following description, various aspects of a novel detachable and optionally wearable control unit and a toys of connected toy systems will be described. For the purpose of explanation, specific configurations and details are set forth in order to provide a thorough understanding of the invention.

Although various features of the disclosure may be described in the context of a single embodiment, the features may also be provided separately or in any suitable combination. Conversely, although the disclosure may be described herein in the context of separate embodiments for clarity, the disclosure may also be implemented in a single embodiment. Furthermore, it should be understood that the disclosure can be carried out or practiced in various ways, and that the disclosure can be implemented in embodiments other than the exemplary ones described herein below. The descriptions, examples and materials presented in the description, as well as in the claims, should not be construed as limiting, but rather as illustrative.

Terms for indicating relative direction or location, such as “right” and “left”, “up” and “down”, “top” and “bottom”, “back” and “front”, “horizontal” and “vertical”, “higher” and “lower”, and the like, may also be used, without limitation.

The present invention is directed is directed to a detachable toy console usable as a control unit for multiple connected toy systems, said toy console is configured and operable to connect interchangeably with at least one smart device and to be attached to a console ready toy and detached from it, to thereby allow a user to use the toy console with another console ready toy. The toy console comprises a MCU; a communication module for establishing connection with at least one smart device; an external connector for attaching and detaching the toy console to the console ready toy; and a power source. The toy console is configured to establish connection and communication with the smart device and the console ready toy and further to perform computations of data received by the toy console before sending it to the smart device, or after receiving it from the smart device. The toy console is further configured to connect with another toy console in an on-line and in an off-line modes, to save data while in an off-line mode, to activate sensors on the toy console and on the console ready toy and further capable of exchanging toys IDs, with another toy console.

The connection between the toy console and the smart device may be established by wired or wireless connection modules selected from the following list: Bluetooth Low Energy (BLE), Bluetooth standard, NFC, IR, USB connection, audio jack connection, Wi-Fi connection, and ultrasonic connection.

The console ready toy comprises at least a toy module, sensors, an external connector to the toy console, and optionally a memory chip. Upon utilizing the sensors of the console ready toy, the information is transferred via the toy console to the smart device and a corresponding reaction, appears on the smart device's screen. The toy module content determines the communication mode between the toy console and the console ready toy and the performance abilities of the connected toy system. The toy module contains input sensors and output sensors allowing the user to interact with the console ready toy via the input sensors and output sensors to create a sound, an image, a LED indication, a mechanical output relay and a buzzer either on the smart device or on the console ready toy itself. The console ready toy comprises sensors and/or buttons attached to it that allows attachment of detachable toy elements in various shapes and characters to be connected to the console ready toy via said sensors, and data created on the console ready toy is processed by the toy console, saved, and displayed by a proprietary app on the smart device. Data created or obtained by the smart device is delivered via the toy console to the console ready toy to create a signal on the toy, said signal is either one of a LED lightened, a buzz is heard, and a movement created by the toy. The sensors comprised in the console ready toy are selected from the group consisting: pressure sensors, touch sensors, odor sensors, temperature sensors, distance sensors, acceleration sensors, humidity sensors, sound sensors, image sensors, proprietary hotspots and tags sensors, and combinations thereof.

The memory chip is used to install a toy ID and a unique serial number, so when the console ready toy is connected to the toy console, the toy ID and the unique serial number are transferred to the toy console and from the console to a smart device for launching a relevant part of the toy app, which transfers the toy ID and its unique serial number to a dedicated server in order to authenticate the toy and to instruct the toy console how to work properly with the specific connected console ready toy. The connection between the toy console and the console ready toy is established in a physical manner or wirelessly by any one of the following connectors: a USB connector, an Edge card connector, a proprietary connector, Wi-Fi, Bluetooth low energy (BLE), Bluetooth, and NFC.

In some embodiments of the invention the toy console is configured to operate as a smart device and upon connection is established between the toy console and the console ready toy authentication process is performed and upon recognition, a relevant toy app is lunched to provide the user an interactive playing experience.

The smart device according to the present invention is selected from the group consisted of: a smart phone, a tablet, a smart TV, TV, a PC, a gamming console, and a micro console.

The detachable toy console may further comprise at least one of the following: function buttons, LED indicators, voice command, offline operating mode configured to allow the user an option to play with the toy without being connected to a smart device, remote control features, a tag reader, and a rechargeable battery. The toy console may further comprise a motion sensor, a gyro sensor and other motion detection elements. The toy console may further be configured to be wearable on the user's hand via attachment to a hand wearable accessory.

Reference is now made to the figures.

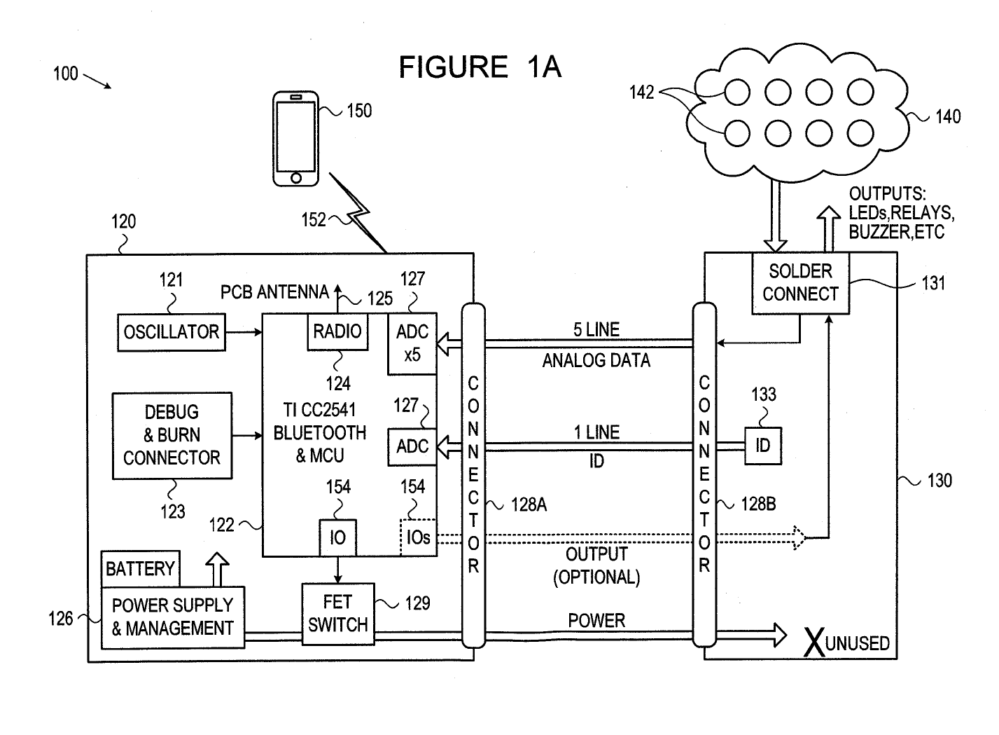

FIGS. 1A and 1B are schematic block diagram illustrations of one operation mode variation of a toy console and a CRT having a complementary toy module in a connected toy system comprising at least: a smart device connected wirelessly (FIG. 1A) or via a cable (FIG. 1B) to a detachable toy console (control unit) and a toy platform containing sensors connected to a complementary toy module.

FIGS. 1A, 1B demonstrate connected toy systems 100 and 100′. Systems 100, 100′ comprise at least a detachable control unit 120, a complementary toy module 130, a CRT 140 comprising sensors 142, and a smart device 150.

In FIG. 1A, Toy console 120 preferably comprises a main PCB in a standalone plastic enclosure which contains a MCU module 122, RF module 124, antenna 125 that is configured to allow connection of the toy console 120 to smart device 150 for transmitting data via BT connection, an external connector 128 comprising two parts 128A positioned on toy console 120 and adapted to be attached to a second part 128B positioned on CRT 140 to functionally connect toy module 130 with toy console 120. RF Module 124 is preferably, a part of MCU module 122. When data is transferred to antenna 125, it is then transmitted via BT to/from smart device 150.

It should be clear that the specific elements comprised in toy console 120 and in toy module 130 may vary from the elements illustrated in FIG. 1, which is only one example of implementation of the invention. It should also be clear that the communication between the toy console 120 and the smart device 150 may be established by other communication modules, including without limitation, a USB connection (FIG. 1B), audio jack connection (modulating data on sound waves received by the smart device microphone), ultrasonic (bidirectional transmission of modulated data on ultrasonic frequencies received by microphone on the smart device and/or on the toy console), and other wireless and wired communication facilities allowing communication between smart device 150 and toy console 120.

In accordance with the specific example illustrated in FIG. 1 connector 128 may be without limitation: a RJ45, RJ12, RJ11, edge card connector, a proprietary connector, Micro USB, Mini USB, and any other suitable connector. Toy console 120 further comprises an accessible battery compartment 126 adapted to provide power to the system via an internal power supply/conversion unit. The battery connector may be a simple two wire terminal allowing connection of a battery pack or AA/AAA batteries, which powers the control unit and the toy module. The internal power supply unit may further be in charge of supporting low battery detection and low current sleep mode supply.

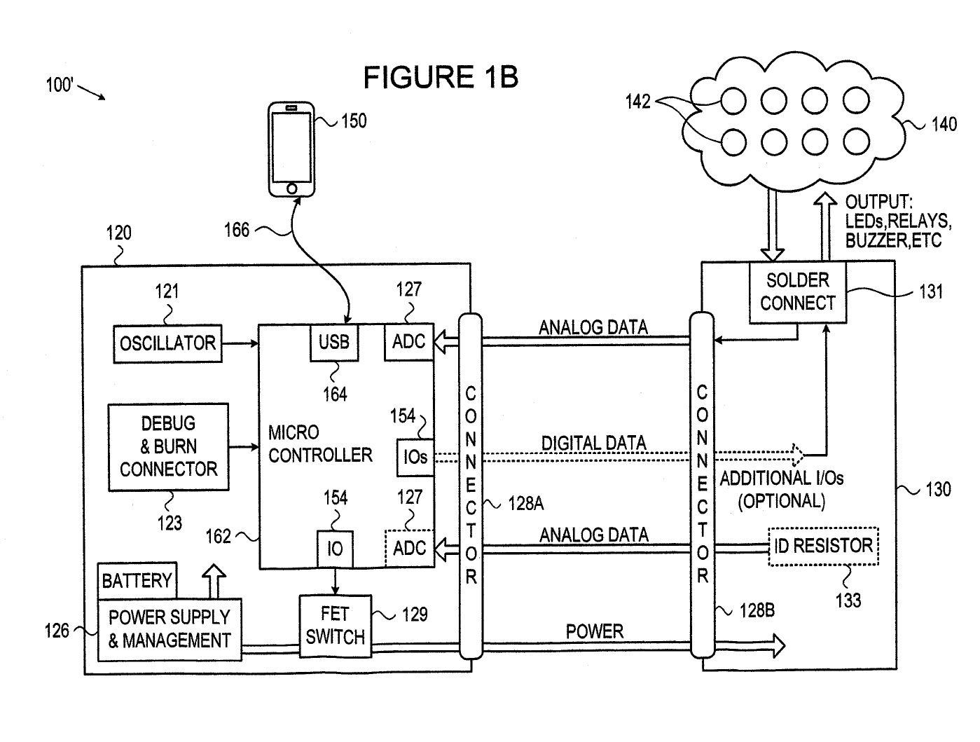

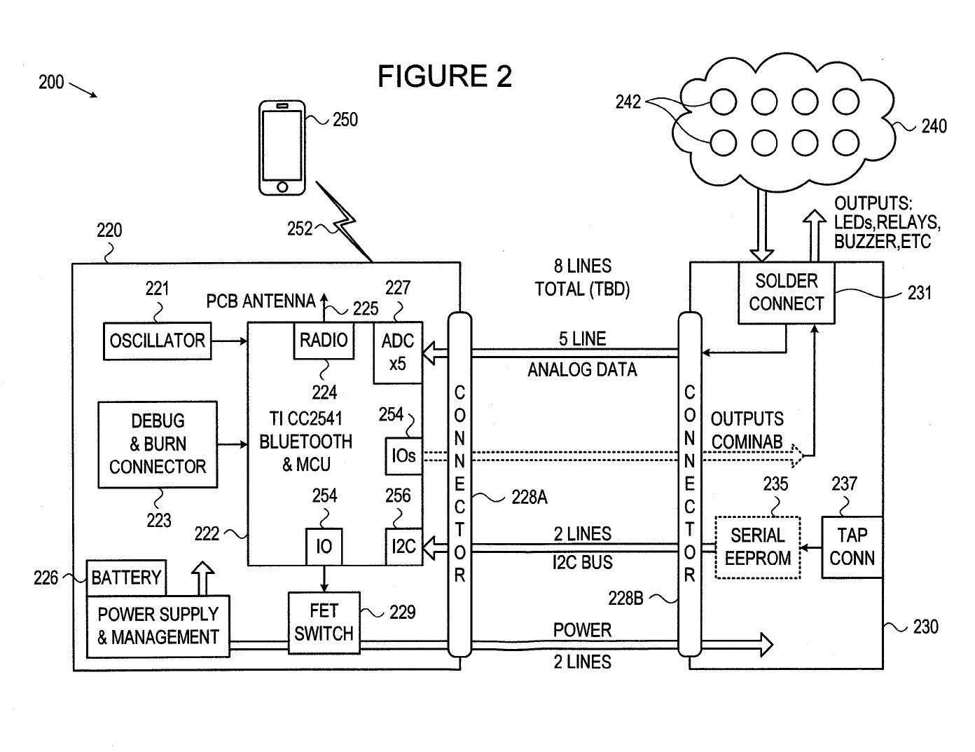

In accordance with the specific example illustrated in FIG. 1A, MCU 122 is a hardware based around a TI CC254x IC, which is a low cost Bluetooth Low Energy (BLE) microcontroller device with 8051 compatible core. The core is in charge of implementing the BLE stack in software, and running the specified firmware operations. Peripherals that may be used on the MCU for this firmware includes without limitation: ADC channels, RF, timers, GPIOs, and I2C master as will be described below with reference to the operation mode of toy module 130 illustrated in FIGS. 2-3.

Detachable Toy console 120 further comprises an oscillator 121 that functions as a clock source for the MCU and RF section. In accordance with variations of the invention detachable control unit 120 may comprise more than one oscillator for example, one high speed accurate oscillator and one slow oscillator low power battery conserving for sleep modes. Toy console 120 may further comprise a debug and burn connector (used for production) 123, and a FET switch 129 adapted to provide controlled power to the toy module (as illustrated in FIGS. 2-3) and connected via an IO 154 to MCU 122. Debug and burn connector 123 is a standard connection according to the TI CC254X requirement allowing firmware burning and a debug port access. FET switch 129 in accordance with variation of the invention may be a MOSFET power transistor that is configured and operable to allow the connection/disconnection of power (from battery 126) to toy module 130 only after a toy connection is detected. A toy connection is detected once the toy console 120 is connected via connector 128 to CRT 140 via toy module 130, then the 10 on the CPU of toy console 120 is sensing a voltage change, thus enabling MOSFET transistor 129 to enable power 126 to toy module 130.

In accordance with variations of the present invention, toy module 130 is preferably made of a small PCB hardware module inserted into (secured to) CRT 140, and it is functionally connected at one end preferably via a solder connection 131 to sensors/output units 142 that are implemented or attached to CRT 140, and to toy console 120 at the other end via connector 128B that is suitable to connect with connector 128A of toy console 120. Toy module 130 is generally in charge of collecting the toy sensors reading and transferring the reading to the toy console 120. In accordance with variations of the present invention, toy module 130 may operate in different modes based on variations of the PCB it is consisted of. Detailed description of exemplary operation modes is provided below.

Toy module 130 further comprises an ID component 133. ID component 133 can be an identifying element (such as resistor) that is connected through a fixed voltage divider to dedicated ADC channel 127 allowing identification of the toy module by resistance encoding. Upon boot, after system initialization detachable control unit reads the toy ID resistor value via ADC channel 127, and the toy type and ID are stored as smart device 150 needs to read this value. In more details, in the variation illustrated in FIG. 1 the ID sensing is performed by ADC channel 127 that is adapted to detect the value of the connected toy module by voltage created on input pin from tapping to the center of a simple voltage divider circuit. For example in FIG. 1A as CC254X has a 12 bit ADC the resistor is sampled via maximum resolution and 4 most LSB bits are omitted (for compensating on accuracy issues), allowing 8 bits of space for hardware versions.

In accordance with the present invention sensors 142 may be without limitation: pressure sensors, touch sensors, odor sensors, temperature sensors, distance sensors, acceleration sensors, humidity sensors, sound sensors, image sensors and combinations thereof. Additionally or alternatively, sensor 142 in accordance with variations of the invention may be a combination of two components: a “Hotspot” and a “Tag”. The term “hotspot” as used herein refers a mechanical element attached to or embedded in CRT 140, allowing the connection of a “tag” to close an electric circuit to one of the channels on toy module 130. A “Tag” as used herein refers to mechanical element attached to or embedded in a detachable toy element (not shown), containing a predetermined resistance value, that when is placed on a hotspot it closes a circuit.

Detachable toy elements are configured according to the opportunities that every specific CRT allows. For example, when the CRT is a savanna then the detachable toy elements may be various animals such as a lion, a zebra, a giraffe, an elephant, or human characters such as an animal savior and his team, a researcher and his team, an exotic tribe members, and various accompanying accessories suitable for each variation. Alternatively, when the CRT is a kitchen then the detachable toy elements may be a plate, a pot, a tea pot, and the like. Similarly, when the CRT is a doll then the detachable toy system may be a wearing particles and accessories such as a shirt, a dress, trousers, skirt, a hat, eye glasses, shoes, bags, and the like.

A detailed description of hotspots and detachable toy elements is provided in PCT/IL2012/000302 and PCT/IL2013/000055 of the same inventors, incorporated herein by reference. When CRT comprises hotspots, solder connect 131 are simple solder holes allowing connection of the hotspots via electric wires.

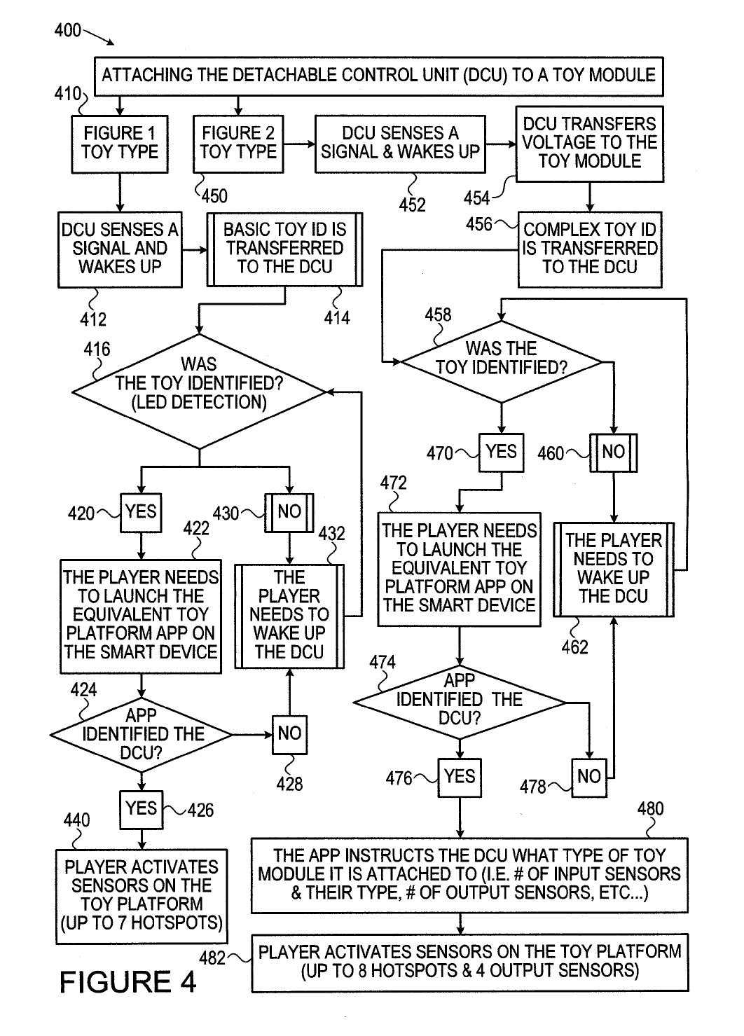

An example of tag sensing upon mating with a hotspot embedded in CRT (toy platform) 140 and attached to toy module 130 via toy console 120 is described in detailed with reference to FIG. 5.

As illustrated in FIG. 1A, smart device 150 may be connected to toy console 120 via a wireless connection such as Bluetooth Low energy (Bluetooth smart) link 152 or other wireless links including without limitation, Bluetooth standard NFC, IR, Ultrasonic communication etc.

FIG. 1B illustrates an optional wire connection between smart device 150 and toy console 120 via a USB module 164 comprised in micro controller 162. The connection between smart device 150 and toy console 120 is established via USB cable 166 inserted into a USB port of the smart device (not shown). It should be clear that other wire communication facilities are also applicable in accordance with the present invention, such as without limitation, a connection via an audio cable that functionally connects the smart device via the audio jack input and the toy console via a GPIO comprised in the micro controller of the toy console (not shown).

Reference is now made to FIG. 2 that schematically illustrates another variation of the connected toy system of FIG. 1. In accordance with variations of the invention, the communication between the toy console and the toy module comprised in the CRT may be established in various manners according to the content of the toy module, wherein each manner allows the entire system connected to these components (the toy console and the CRT) different performance abilities (different operation modes) as will be described henceforth.

In accordance with variations of the invention toy module 230 may consist of a simple electronic PCB with solder connection to sensors 242, and direct wiring to connector 228, thus, allowing a direct read of the resistance values by an ADC positioned on toy console 220. Alternatively, the ADC may read current values, and any physical values according to the sensors type implemented in toy platform 240. In the specific example illustrated in FIG. 2 the identification of the toy is performed in a different manner than in FIG. 1. FIG. 2 illustrates a toy module 230 that contains both, input sensors and output sensors. Meaning, when connecting toy console 220 to toy module 230, the player is able to interact with the toy via the input sensors such as hotspots 242 and output sensors like sound or image sensors or LED indicators (not shown). Thus, interaction may be responded by both: by smart device 250 and by output sensors (not shown). In the examples illustrated in FIG. 2, toy module PCB 230 contains eight analog channels, which are designated for connecting a plurality of sensors 242 implemented or attached to CRT 240. In addition, two lines are used for connection between the I2C on the PCB of toy console 220 and a Serial EEPROM 235 positioned on toy module 230 via I2C Bus 256. In the variation illustrated in FIG. 2 toy console 220 and toy module 230 are connected via eight lines for input sensors, two lines for power, two lines for I2C Serial memory EEPROM and one line for toy detection.

Serial EEPROM 235 is basically a memory unit which can store a unique serial number of toy module 230 that is used for toy authentication. This is used as another option for toy identification (instead of a simple resistance value) The Toy ID Serial EEPROM 235 may contain a certain amount of bytes generally containing the toy's hardware type and serial number of the toy module, and resides on an I2C bus 256 on an address to be determined by the programmer. Toy console 220 is configured and operable to transfer a digital number that was received from toy module 230 upon attachment to a dedicated app on the smart device, which further connects to a server to receive from it the information regarding the number of inputs/outputs of the specific toy module attached to it. This information is then being transferred to toy console 220.

Serial EEPROM 235 also have reserved space for further future data. When a serial EEPROM 235 is positioned on toy module 230 the module further comprises a tap connector 237, which in the specific example illustrated herein is an I2C+VCC+GND, 6 pin simple solder hole connection allowing the burn in of the EEPROM serial number on toy module 230.

In the variation illustrated in FIG. 2, additional line is connected between IOs positioned on toy console 220 and toy module 230 that further allows additional output sensors such as LED's, mechanical outputs (relays) and buzzers to be activated on CRT 240.

All other components illustrated in this figure have a similar functionality as described with reference to FIG. 1 in the above.

Reference is now made to FIG. 3 that schematically illustrates a block diagram of one another example of operation mode of a toy console 320 and a CRT having a complementary toy module 330 in a connected toy system 300.

In the specific example illustrated in this figure, toy module 330 comprises a data bus 356 such as a standard 2-wire half-duplex serial protocol between integrated circuits (ICs) and peripherals such as I2C or SPI, a compatible IO expander 334 configured to translate the serial commands into outputted GPIO lines that acts according to a select index for an Analog Multiplexer(s) (Mux) 336. Thus, allowing connection of multiple sensors 342 while keeping the number of connections on the connector between the CRT and toy console low (up to 16 in the specific example illustrated in this figure) to CRT 330 via linear scanning, and reading by 1 ADC channel 327 positioned on the toy console 320 that functionally receives the output of Mux 336 via connector 328.

IO expander 334 is a standard chip that can convert I2C serial commands into discrete digital 3.3V IO lines. In the specific example illustrated in this figure, as only four (4) lines are needed for scanning inputs with sixteen (16) inputs analog mux the excess lines of the twelve (12) lines (or 4, depends on the specific chip that is in use), can be used as general purpose outputs (i.e. LEDs, buzzers, mechanical relays, and the like.). Analog multiplexer 336 functionally select one input (according to its digital select port) and connect it to its output.

In addition to the above, other components as illustrated with reference to FIGS. 1 and 2 are also included in the operation mode illustrated herein and having a similar functionality. These components include an oscillator 321, debug and burn connector 323, a battery 326, and a FET switch 329 connected via an IO 354 to MCU 322.

In the specific operation mode illustrated in FIG. 3, the specific hardware of toy module 330 comprises at least the following: I2C GPIO expander, I2C EEPROM memory, and analog multiplexer. In this variation the CRT 340 comprises maximal amount of sixteen (16) sensors. However, it should be clear to a man skilled in the art that other types of operation modes may be defined along with other platforms and a firmware on the toy console that are able to support it. In this specific variation, the toy module PCB preferably but not necessarily contains an I2C serial memory for storing long unique serial numbers and additional data. Also any additional I2C compatible chip can be added to further expand the functionality.

Additional variations of other modes for toy module may include different I2C chips configured to allow additional functionalities via communication to the master processor, including without limitation: display means (preferably a screen), additional sensor types, accelerometers, gyroscopes, larger memory modules, audio means such as microphone, loudspeaker, and audio processor. This will allow enhancement and addition of features to the toy without the need to change the toy console hardware. Thus, allowing a user a simple and friendly operation of the connected toy system especially upon changing one CRT 340 with another, as there is no need to use a different dedicated toy console to each toy platform. For example in a family having small children in ages two, five and seven. When the seven years old child desires to play with the toy system the only operation the child/parent should perform is to detach the toy console from the previously used CRT and to connect it to the new one to be used. Thus, one toy console may be used for the entire family with different toy platform. Additionally, a substantive economy in electric wastes production is achieved that further allows keeping the environment clean and green.

In accordance with variations of the present invention the toy consoles 120,220,230 illustrated in FIGS. 1-3 (i.e. the main PCB with the MCU), are in charge of managing the entire toy connected system (i.e. systems 100, 200, and 300 respectively), and configured and operable to communicate with toy module 130,230,330 positioned in CRT 140, 240, 340 respectively, via multiple lines through connectors such as RJ45, RJ12, RJ11, edge card connector, and a proprietary connector. Toy consoles 120,220,320 are further in charge of establishing connection with the smart devices 150,250,350 respectively, either in a wireless manner, for example via Bluetooth low energy links 152,252,352, or via cables such as USB cable 166, audio cable or audio cable. Toy consoles 120,220,320 of the invention may further comprise a screen (touch or not), a microphone, a speaker, accelerometers, gyro sensors, other type of sensors, and other input and output elements.

Toy module 130/230/330 is mainly a small PCB hardware module, which is fitted within the CRT 140/240/340 and is in charge of collecting the toy sensors 142/242/342 reading and transferring/delivering the data to the toy console 120/220/320. As mentioned and illustrated above the different operation modes of each connected toy system is de facto determined according to the specific elements contained in the toy module 130/230/330 PCB as the elements on the detachable toy console are the same for all.

Detachable toy console 120/220/320 may contain a LED (not shown) that will be exposed, for example, through a plastic casing of the toy console. For example, the LED may be a bicolor LED with red and blue lights. In such example the following exemplifying modes are optional:
Off mode—Toy console is turned OFF/In sleep mode.
Green blinking slow—Toy console is ON, waiting for connection with smart device.
Green blinking fast—Toy console is ON, connected to smart device, waiting for connection with toy module.
Green constant—Toy console is ON, connected to the toy module and to the smart device.
Green/Red Blinking—Toy console is ON and connected, Low battery.
Red blinking—Toy console is ON not connected, Low battery.
Red constant—Toy console is ON, malfunction.

In addition to the above, a pushbutton (not shown) may be added to the toy console configured to allow a user to interact with the toy console as follows:
Short press—wakeup (when on off/sleeping mode);
Long press (3 sec)—reinitialize Bluetooth advertising mode;
Very long press (5 sec)—system reset.

It should be clear to a man skilled in the art that although the hardware of the detachable toy console 120/220/320 illustrated in the exemplary variations in FIGS. 1A, 2, 3, and 6 are based around a TI CC254x IC, which is a low cost Bluetooth Low Energy (BLE) microcontroller device with 8051 compatible core other micro control units are also applicable for the present invention, and other communication modalities either wireless or by physical wire connection are also suitable for the purposes of the invention. In the specific example illustrated in these figures, the core is in charge of implementing the BLE stack in software, while drivers for the BLE stack are provided by TI. The BLE chip will be operating a toy platform, which may contain an array of sensors and inputs (hotspots+tags, push buttons, piezo-electric pressure sensors, accelerometers, and the like), as well as output units (e.g. LEDs, buzzers, relays, and the like). Furthermore it is configured to establish BLE connection with BLE compatible smart device such as without limitation: iPhone 4S, iPhone5, iPhone 5S, iPad (3^{rd}, 4^{th} gen), iPad air, iPad mini (with/without retina display), Motorola RAZR 2012, Samsung Galaxy S3, Google Nexus 7 tablet, and any smart device running Android OS 4.3 and above and others.

The firmware for operating the detachable toy console and the complementary toy module of the present invention is adapted to communicate the state of the sensors to the smart device via correct BLE stack encapsulation of the data (service/characteristic, etc.), and will respond to report any change carried by a user on one of the sensors on the CRT. Furthermore, it is configured to operate the CRT to light up LEDs according to requests from the smart device (application).

Fundamental functionalities that shall be implemented in the Toy console firmware supporting the hardware of the present invention while sensors are Tags and Hotspots are listed below:
1. Advertise and establish BLE connection.
2. Smart Device→Toy console: Get current input status (update hotspots/sensors readings) and report to smart device.
3. Toy console→Smart Device: Report current input status (update hotspots/sensors readings) upon user change. →4. Smart device→Toy console: Write certain output state to the output devices on the toy (i.e. LEDs).
5. Toy console→Smart device: Read control unit (toy console) serial number (should be a reserved area in the internal flash memory for bits serial number).
6. Toy console→Smart device: Read toy module serial number (read I2C EEPROM memory contents).
7. Toy console→Smart Device: Report type of toy connected (Toy ID)—, HW revision, etc.
8. Toy console→Smart Device: Report firmware & hardware version of control unit connected.
9. Smart Device→Toy console: update and burn new control unit firmware (new firmware can be downloaded to device from the smart device).
10. Toy console→Smart Device: Report unexpected error/log to application.
11. Toy console→Smart Device: Report low battery state Smart device→Firmware: Enter sleep mode (App is closed).
12. Smart Device→Toy console: Kill connection & reboot.

In the following description, examples of the firmware for different operation modes are described.

In accordance with the operation mode illustrated in FIG. 1A, the firmware is in charge of detecting a change in hotspot/sensors state via direct sensor per ADC channel connection. Thus, a maximum of eight hotspots/sensors are connected to eight ADC channels on PO of the TI CC254X chip. In such scenario, firmware is scanning the values of the eight ADC readings continuously, and whenever a large change is detected (for example a change >5% from previous value), new value should be de-bounced (wait for stabilization of the reading within 5% bounds for 150 ms) and requirement No. 3 above shall be initiated. Upon boot, after system initialization the toy console reads the toy ID resistor value (via a ADC channel) and the type and ID should be stored internally as the smart device needs to read it.

Additionally or alternatively, when a toy ID is detected as a specific operation mode or as another specific operation mode, this initiates the relevant firmware behavior for the toy type.

In the operation mode illustrated in FIG. 3 the firmware continuously scans the sensors, for example maximum amount of sixteen (16) hotspots by sending I2C commands to the IO expander every specific time period (for example, every 25 mS). The IO expander will output sequentially increasing mux select values for incrementing the hotspot number currently being scanned by the single dedicated ADC input. Similar to the operation mode illustrated above, in this mode also a change larger than 5% of previous read value for the specific hotspot will be reported to the smart device via BLE transmission as a change per requirement No. 3 listed above.

The Firmware is further able to change the other unused pins of the IO expander to output LED light statuses etc. Different from the first operation mode described in the above, in the operation mode described in FIG. 3 the boot process that occurs in order to determine the firmware behavior type is as follows: upon boot, after system initialization and toy attachment the toy console reads the CRT ID memory device via I2C operation, and stores the data internally as the smart device will need to read it in order to configure the toy console to operate correctly with the currently attached CRT (toy platform) and toy module.

In sleep modes the toy console does not have an on/off switch therefore it should enter low power mode, whenever one of the following occurs:
1. Requested by the remote app via BLE connection command/termination/exit application;
2. Waiting for a toy module to be connected;
3. No user interaction for the last predetermined period of time;
4. Advertising and waiting for a BLE enabled smart device to connect over a predetermined period of time.
   Exit from a sleep mode is performed whenever one of the following occurs:
1. Requested by the remote app via BLE connection command;
2. User interaction occurred on toy;
3. User press on toy console button.

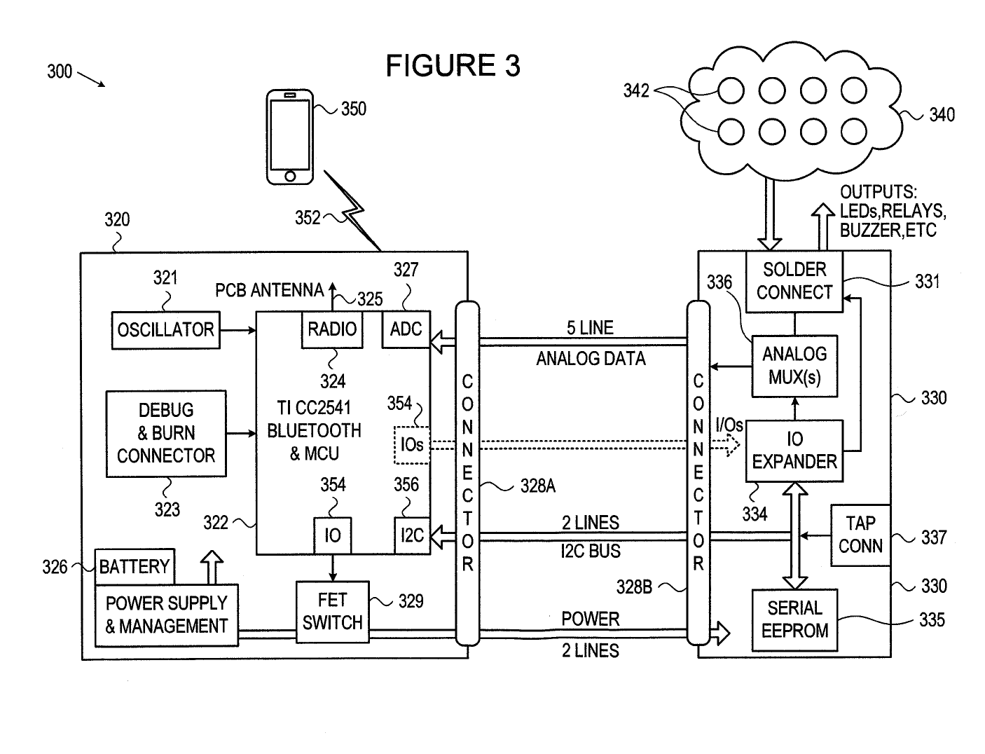

FIG. 4 is a flowchart illustration 400 of two optional operating modes of a connected toy system comprising the detachable toy console connected to either one of the toy modules illustrated in FIGS. 1 and 2.

Upon attaching a toy console (i.e. a detachable control unit (DCU)) to a toy module type illustrated in FIG. 1 (step 410) DCU senses a signal and wakes up (step 412) and a basic toy ID is transferred to the DCU (step 414). Was the toy identified and a positive LED detection occurred (step 416). If Yes (step 420) a player should launch the equivalent toy system app on the smart device (step 422), or the app opens automatically (if supported by the smart device). Is the app identifies the DCU (step 424)? If Yes (step 426) the player may activate sensors (up to seven sensors) on the CRT (i.e. toy platform) (step 440). If the app is not identified by the DCU (step 428) then, return to step 432. If the toy is not identified in step 416 (step 430), then the player need to turn on the DCU (step 432) and return to step 416.

Upon attaching a toy console (DCU) to a toy module type illustrated in FIG. 2 (step 450) DCU senses a signal and wakes up (step 452) and enables power to the toy module (step 454). Toy ID is transferred to the DCU (Step 456). Was the toy identified and a positive LED detection occurred (step 458)? If Yes (step 470) A player should launch the equivalent CRT (toy platform) app on the smart device (step 472). Does the app identify the DCU (step 474)? If Yes (step 476) the app configures the DCU according to the type of toy module it is attached to (i.e. number of input sensors and their type, number of output sensors, etc.) (step 480), and then the player may activate sensors on the CRT (toy platform) (step 482). If the app is not identified by the DCU (step 478) then, return to step 462. If the toy is not identified in step 458 (step 460), then the player needs to wake up the DCU (step 482) and return to step 458.

Similar to the above operation flow for toy modules comprising a Multiplexer the player can activate up to sixteen hotspots via analog mux IC and seven more hotspots via the ADC. Also, the number of output sensor may increase to eleven. In such scenario, seven (7) ADC channels are free to be used as sensor (input and output sensors). Thus, it allows addition to the existing sensors.

Reference is now made to FIG. 5 that schematically illustrates a tag sensing circuit demonstrating sensing of a tag mated with a hotspot in a CRT by a detachable toy console connected to a toy module positioned within the CRT in accordance with variations of the invention. As illustrated in the figure, ADC channel 327 detects the value of the connected tag resistor 345 by the voltage created on this input pin from tapping to the center of a simple voltage divider circuit with a fixed 1% accuracy 10 Kohm resistor 360 tied to the power supply Vcc rail 362 and the tag resistor 345 tied to ground 368. Center pin of the voltage divider is passed through the toy module and toy console connectors. The tag resistor list values are created in firmware and the comparison is performed in predetermined accuracy ranges of the reading.

### EXAMPLE 1

### Tag Sensing

Tag resistor=2.5K
Pull up resistor=10K
Vcc=3.3V
so we get a voltage reading of 3.3*(^{2.5}/_{2.5+10})=0.66V, theoretically defining port as rail-to-rail 10 bit ADC the result will be: 1024*0.66/3.3=205.
   Thus, for a tag with 2.5K the firmware will detect the tag as any ADC reading in the range of: 195˜215.
   Tolerance range around the reading value can be defined by software to allow use of different tolerance resistors and to compensate for wires/hotspot resistance.

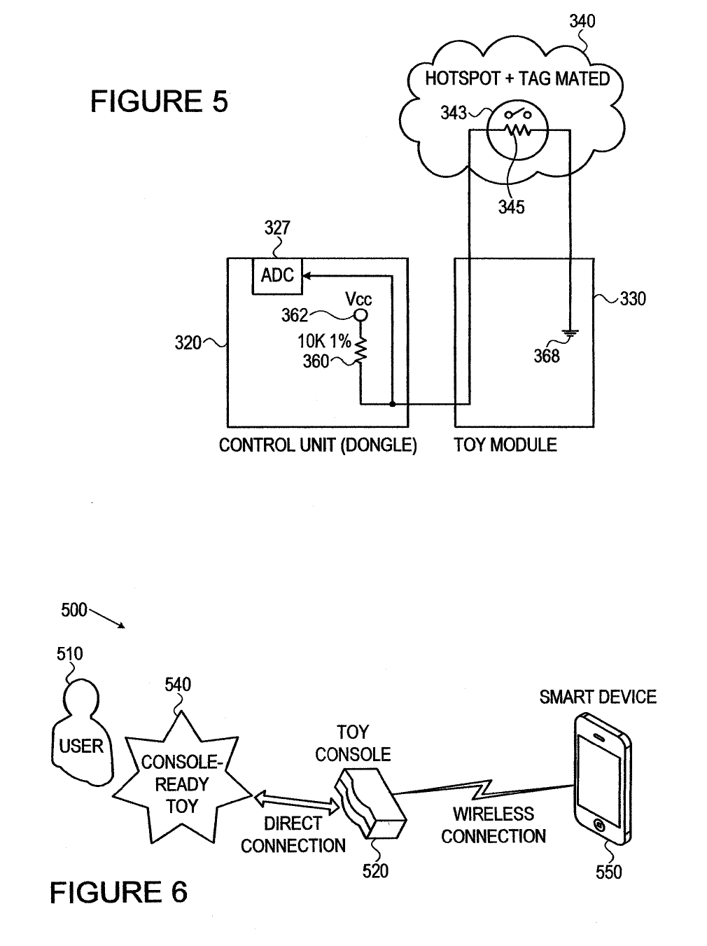

Reference is now made to FIG. 6 that schematic illustrates another example of a connected toy system 500 with a toy console 520, a CRT 540, and a smart device 550. The CRT may further comprise sensors configured to allow attachment of variety of detachable toy elements according to the CRT theme.

In accordance with the present invention, a toy may become a “Console-ready” if it includes at least connection ability to the console, and a set of sensors embedded in the toy. When utilizing the sensors, the information is transferred via the toy console to the smart device that is configured to communicate with the toy console (as it comprises an appropriate app), and a corresponding reaction on the smart device's screen appears. The connection between the CRT and the toy console is preferably established in a physical manner (i.e. via a USB connector, an Edge card connector, a proprietary connector, and the like). However, the connection may also be established in a wireless manner by any know wireless communication technology known in the art and mentioned above.

A variety of sensors may be applicable when playing with the CRT including without limitation: pressure sensors, touch sensors, odor sensors, temperature sensors, distance sensors, acceleration sensors, humidity sensors, sound sensors, image sensors and combinations thereof. Moreover, a set of proprietary sensors may also be used as described in details in PCT/IL2013/000055 mentioned above. These proprietary sensors are embedded in the CRT and generally allow recognition of every detachable toy element attached to the CRT. Thus, when a player places a detachable toy element on any given sensor on the CRT when it is connected to the toy console, then this information is transferred via the toy console to the smart device and a corresponding reaction on the smart device's screen appears.

In hardware specs, the CRT illustrated in this figure preferably comprises at least the following: sensors, toy module PCB, connector to the toy console, and a memory chip. The memory chip, for example a EEPROM, is used to install a toy ID and a unique serial number, so when the CRT is connected to the toy console, the toy ID and the unique serial number are transferred to the toy console and from the console, wirelessly, to a smart device. Then, the smart device is launching the relevant toy app, which transfers the toy ID and its unique serial number to a dedicated server in order to authenticate the toy (using the toy ID) and to instruct the toy console how to work properly with the specific connected toy (using its serial number).

The detachable toy console provided herein is configured and operable to connect to smart devices, and once connection is established then a relevant app is launched on the smart device. Then, a fully interactive playing experience awaits the user. For example, the CRT may be a family house with 3 rooms, some family figures (mother, father, baby, and a dog) and a designated position to place the smart device. The player can play with the family house as a usual toy, but once it is connected to the toy console, the playing experience is practically endless. The player can choose to explore the house with either one of the character, which will appear on the screen of the smart device and describe its where about in the house. Moreover, the player can choose to play a quest in the house, so the app on the smart device instructs the player to use all the characters in different interactions and in different rooms inside the house in order to solve the quest.

In accordance with one another example, the CRT is an education/learning board, which comes with different characters dressed in their profession, such as a doctor, a fireman, a teacher, a police officer, and the like. Once connecting the board to the toy console, the player is to obtain different educational content about the professions. When the player is a child he can learn the vocabulary of the professions and their scope of work. Furthermore, educational videos may be screened on the smart device in response to placing a character on the board, thus learning about each profession or its related issues. For instance, when placing the doctor on the board and choosing a video mode, then videos about the human body may be screened to the child, or when placing the fireman then videos about the risks of fire may be screened to the child, and such. The gaming options are endless and the playing experience is much higher.

The toy console is further configured to operate as a smart device, and once connection is established between the console and the CRT authentication process is performed and upon recognition, a fully interactive playing experience awaits the user.

As mentioned above, at its basic feature, the toy console should have the ability to connect to the CRT and to the smart device in either a wired or a wireless manner.

In some embodiments, the CRT may be attached to the toy console directly via a USB connector, an edge card connector, a proprietary connector or any other suitable connector. As for the connection between the toy console to the smart device, it is preferred to be wireless so it will be able to connect to variety of smart devices in the market and at home according to the user preferences and family containments. Relevant hardware components should be incorporated inside the toy console. In the example above, the toy console should have a physical connector connected to its PCB, a MCU for wireless connectivity and other components to allow receiving data from the toy itself and transferring it, wirelessly, to the smart device. Additionally a power source is also required.

In addition to the above, the toy console may further comprise additional features and options, which functionally allow a better communication and functional abilities, and consequently a better playing experience. The toy console may comprise, among others, the following features: function button/s, LED indicator(s), offline Mode to allow the user an option to play with the game without being connected to a smart device, Remote control features such as 5-Way Joystick, touch pad, touch screen, motion controls, a tag reader on the console (e.g. RFID, Optical), an improved connectivity (Wi-Fi connectivity, Standard Bluetooth, BLE (Bluetooth 4), a rechargeable battery, sensors such a gyro, accelerometer, and proximity sensor.

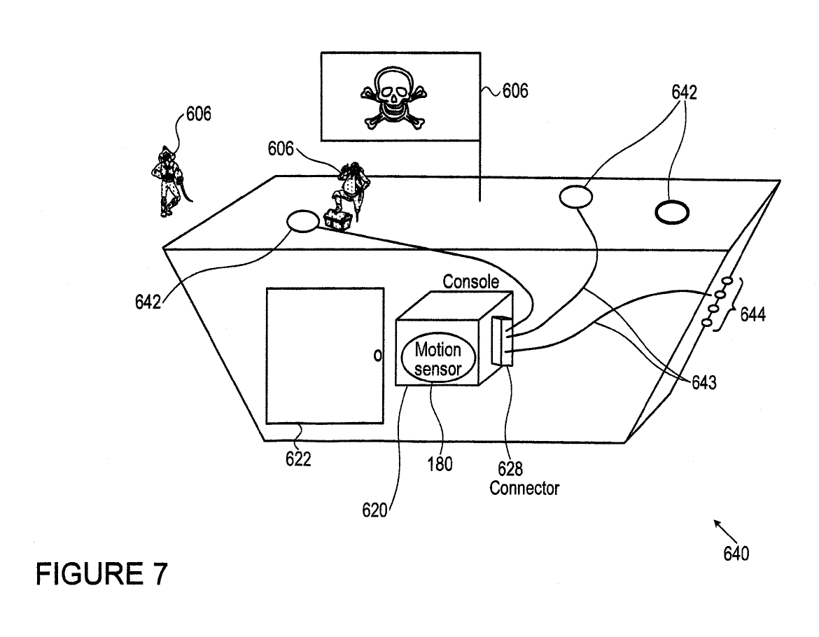

FIG. 7 is a schematic illustration of a detachable toy console 620 having a motion sensor 180 connected via connector 628 to a CRT 640 that is shaped as a pirate ship. The board of the ship may functions as a recognition surface that allows recognition of detachable toy elements by various means including sensors and hotspots 642 configured to be reversibly attached to various detachable toy elements 606 some of them shaped as pirates and ship flag. Hotspots 642 are connected to a toy module by wires 643 that is further connected to the toy console 620. In the specific example illustrated in this figure, the toy console 620 is positioned within the CRT in a dedicated socket 622. As the toy console comprises a motion sensor, any movement of the ship is being identified by the toy console and interpreted in the smart device. The board of the ship may be used as a recognition surface, wherein recognition may be achieved for example by RFID or by graphic recognition. The ship further comprises LEDs 644.

In accordance with another aspect of the invention a wearable toy console usable as a control unit for multiple connected toy systems is provided. The wearable toy console is configured and operable to connect interchangeably with at least one smart device and to be carried by a toy and/or by a wearable accessory on the hand of a user, wherein the wearable toy console is configured to be passed by the user from one toy to another or to the hand wearable accessory so as to allow the usage of the toy console with multiple toys. The toy console comprising: a MCU; a communication module for establishing connection with at least one smart device; a motion sensor configured and operable to allow reading of movements by the smart device; and a power source.

The motion sensor in configured to simulate movement of the toy carrying the toy console upon movement of the toy console itself, as the toy movement rides on the toy console movement and interpreted as if the toy is connected to the toy console. The data obtained from the motion sensor is saved on the toy console and can be used in an offline and online modes, and may be saved on the toy console and be used in a later time. Similar to the detachable toy console the wearable toy console may operate in the same manner and contain sensors and buttons as well as other features that provide the wearable toy console configured to connect to a pseudo connected toy as defined above the same characters and capabilities as the console configured to be attached to a console ready toy.

The identification of the toy carrying the wearable toy console is established by wither one of the following options: a) by selecting the relevant toy from a list or other visual representation of toys on the smart device screen; b) by entering an ID code which appears on the toy or on its packaging to the smart device; c) by introducing the toy to a camera on the smart device and using image recognition techniques; and d) by introducing a QR code or a similar visual code printed on the toy or on its packaging to a camera of the smart device and a software, running on the smart device, uses the camera to take a picture of the visual code, and to analyze the visual code.

The toy console may be inserted into a dedicated pocket or groove on the toy or on the hand wearable accessory. Alternatively, the toy console is reversibly attached to the toy or to the hand wearable accessory by mechanical means selected from the group consisting: a Velcro, connecting strip, magnet, and sticky material. The hand wearable accessory is selected from either one of a glove or a bracelet.

In accordance with specific variation, the toy in use with the connected system is a wearable toy configured to carry within it the toy console or carried by the hand wearable accessory and the user is playing with a virtual toy selected and displayed on the smart device. The wearable toy console may further comprise at least one of the following: function buttons, LED indicators, remote control features, voice command, offline mode, activation of sensors, memory, connection ability with other toy consoles, exchanging toys ID information, and a rechargeable battery.

The present invention is further directed to a detachable toy console usable as a control unit for multiple connected toy systems, said toy console is configured and operable to connect interchangeably with at least one smart device and to be attached to or to be carried by a toy and/or by a wearable accessory on the hand of a user, wherein the detachable toy console is configured to be passed by the user from one toy to another or to the hand wearable accessory so as to allow the usage of the toy console with multiple toys, said toy console comprising: a MCU; a communication module for establishing connection with at least one smart device; connection elements configured to allow reversible attachment of the toy console from to the toy and/or to allow carrying of the detachable toy console by a toy and/or a wearable accessory; a motion sensor; and a power source.

Detailed description of the wearable toy console is provided with reference to the following figures.

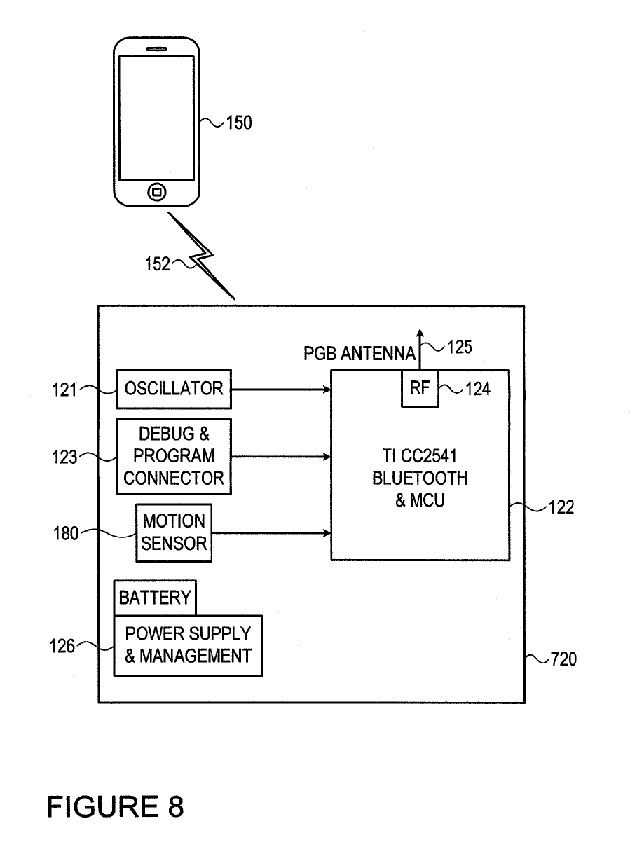

FIG. 8 is a schematic illustration of a toy console 720 configured and operable to be connected with a smart device 150 in a connected toy system, in which the toy is a non-electric toy i.e. a pseudo connected toy as defined above. This form of toy console may further be used without a hand wearable accessory configured and operable to hold the toy console. Wherein the toy is a virtual toy selected by the user in a dedicated app on the smart device. The toy console 720 illustrated in this figure is similar to the toy console illustrated in FIG. 1 besides the following: it has no connector for connecting with a complementary toy module and it comprises at least a motion sensor 180 in order to simulate movement of the pseudo toy or the virtual toy upon movement of the toy console itself. The toy console in this variation electrically connects solely with the smart device, and the toy movement actually “rides” on the toy console movement and is interpreted as if the toy is connected while it is not. Thus, the toy console may be fully operated without a toy. In such scenario, the user holds/wear the toy console and plays with it in front of the smart device with a dedicated app.

All other components viewed in this figure are similar to the components described with reference to FIG. 1A.

Identification of a pseudo connected toy may be established by various techniques, some are presented below:
1. Manual—by a list. The user uses the touch-screen, or keyboard, or another input device, to select the toy from a list or other visual representation of toys on the smart device screen. The software may use a remote server to get an update data to be used on the list.
2. Manual—by a code. The user uses the touch-screen, or keyboard, or another input device, to type a ‘code’ of several digits/letters/characters, which appears on the toy or on its packaging. The software may use a remote server to identify the code.
3. Camera—when the smart device has a camera, the user can show the toy to the camera. The software, running on the smart device, uses the camera to take a picture of the toy, and to analyze the picture using image recognition techniques. These techniques may rely on a pre-loaded collection of data about the possible toys. These techniques may also rely on a remote database, which runs separate software for the picture analysis and uses a database for that purpose.
4. QR code—when the device has a camera, the user can show the QR code or a similar visual code to the camera. The visual code is printed on the toy or on its packaging. The software, running on the smart device, uses the camera to take a picture of the visual code, and to analyze the visual code. The software may use a remote database, which runs separate software for the visual code analysis.

Since the same console is used with different toys, and sometimes different toys could fit the same game logic, when a new toy is released to the market, “graphic contents” about the new toy is uploaded to the server. When a user connects the console to the toy, the smart device recognizes the toy type and downloads the fitting ‘graphic contents’ from the server. In this manner, each game, which is relevant for the toy, can make ‘dynamic binding’ of the ‘graphic contents’ to the toy will be presented to the user.

If an accelerometer or Gyro (or other sensors) are built into any configuration of the toy console presented herein, a “calibration” action is required. The calibration is done after to console is connected (or pseudo connected) to the toy for determining the ‘base’ position of the toy console.

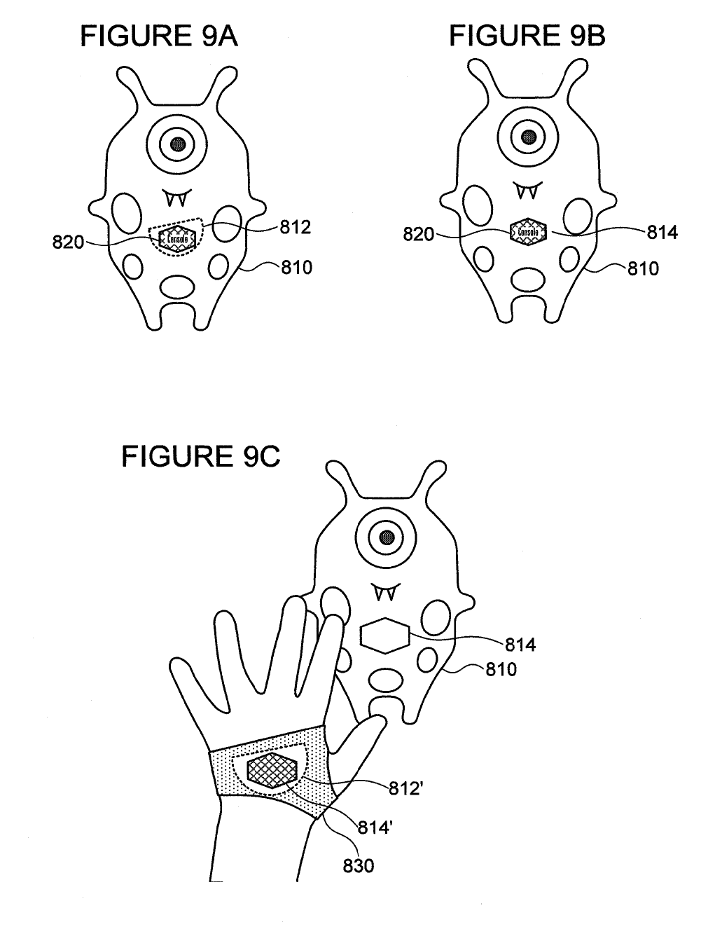

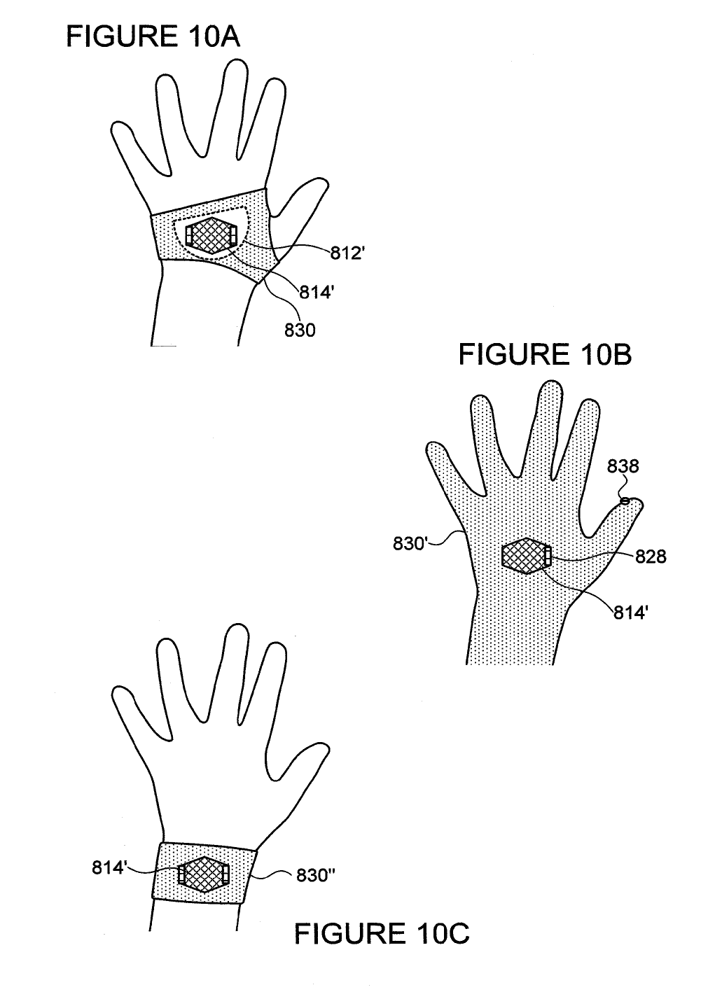

FIGS. 9A-9C are schematic illustrations of a pseudo connected (non-electric) toy 810 wherein, FIG. 9A illustrates a toy 810 having a special pocket 812 configured to hold the toy console 820. FIG. 8B illustrates another variation of toy 810 having a mechanical connection means 814, for example Velcro, magnet, sticky surface and the like, positioned on it for holding the toy console 820 having the same or a complementary component. FIG. 8C illustrates one another variation of toy 810 in this variation, the toy is configured to be attached to a hand wearable accessory 830 such as a glove or a bracelet by mechanical means 814 positioned on the toy and complementary means 814′ such as a Velcro or a magnet or a sticky plate positioned on the wearable accessory 830, wherein the wearable accessory 830 comprises a special pocket 812′ for holding the toy console. Additional variations of toy 810 may be for example a toy without any mechanical attachment means that the user simply holds in his hand, and a toy that comprises an internal socket for placing the toy console. Additional variations of the wearable accessory 830 are illustrated in FIG. 10.

FIGS. 10A-10C illustrate some examples of wearable toy consoles, connected or positioned to a hand wearable accessory 830, 830′, 830″. FIG. 10A illustrates a glove 830 having a dedicated pocket 812′ on the back side of the hand for holding a toy console within it. The glove may also comprise mechanical attachment means 814′ to allow attachment of the glove to a non-electric toy (toy not shown). FIG. 10B illustrates another variation of a wearable toy console configured as a whole glove 830′ having a toy console hidden within it, wherein an electrical connector 828 is positioned on the outer surface of the glove to allow attachment to a console ready toy, and also a mechanical attachment means 814′ to allow a user to connect the console also with a pseudo connected toy. Wearable toy console 830′ may further comprise a sensor and/or buttons 838 for use with a CRT when connected. FIG. 10 C illustrates a bracelet 830″ having a dedicated internal pocket for holding the toy console (not shown), and a mechanical attachment means 814′ for holding a non-electric toy.

All types of connections illustrated above 812′, 814′, and 828 may be applicable with any wearable design.

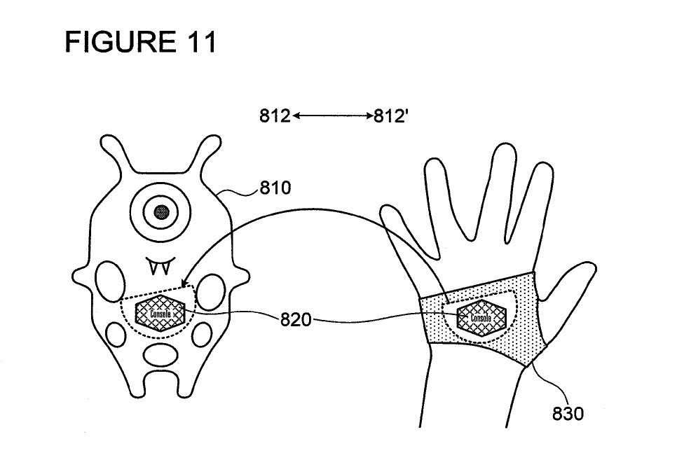

FIG. 11 schematically illustrates a wearable toy console 820 positioned within dedicated pockets in a glove 830 and in a pseudo connected toy 810, wherein the toy console may be transferred from one pocket 812 to the other 812′ and vice versa according to the user's preferences.

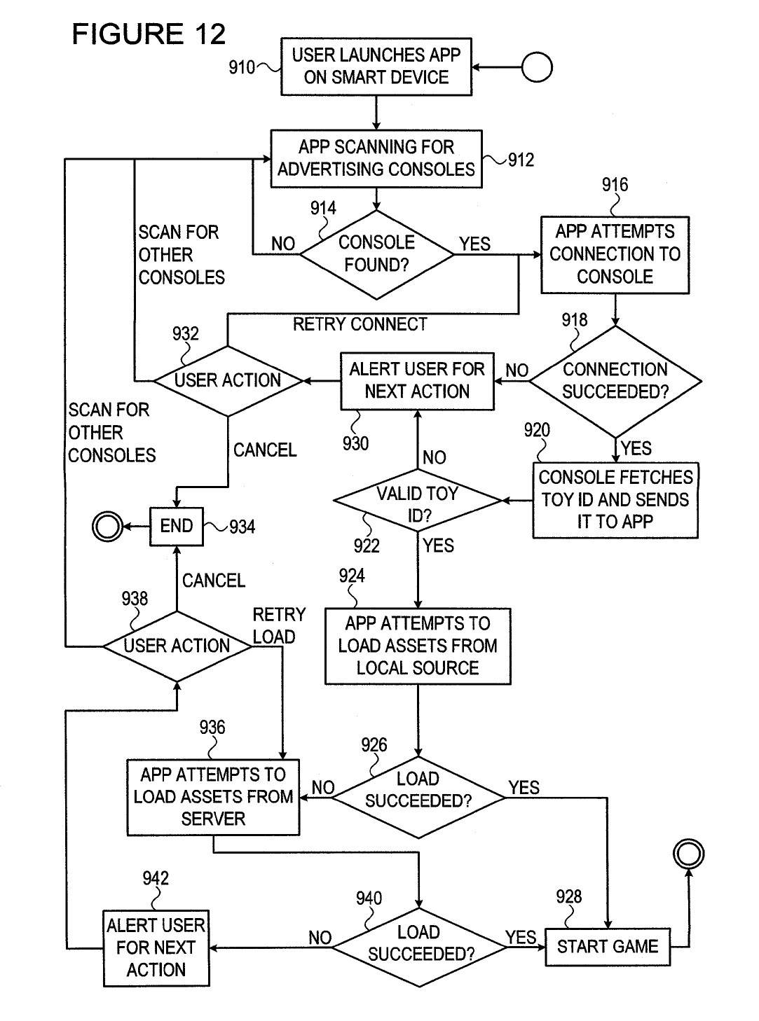

FIG. 12 is a flow chart illustrating one example of dynamic assets loading for connected toy mobile application. The diagram details the flow of events, actions and error handling in a common use case in which the user connects a mobile application on a smart device to a physical toy, attached to a toy console of the present invention. Then, verification and identification of the toy ID is performed, and finally, a process of dynamically loading required multimedia assets, such as graphics and sounds is performed, according specific app and the toy ID.

When a user launches app on a smart device (step 910) the app is scanning for advertising consoles (step 912). Is a console found? (step 914). If No, return to step 912. If Yes, the app attempts to connect with the toy console (step 916). If connection succeeded (step 918) the console fetches the toy ID and send it to the app (step 920). If connection is not succeeded the app alerts the user for next action (step 930), the user should take action (step 932) whether to retry connecting to the console (step 916), scan for other consoles and return to step 912 or to cancel the process and end (step 934). Is the toy ID valid? (step 922), if No, go to step 930. If Yes, app attempts to load assets from local resource (step 924). Is the loading succeeded? (step 926) If Yes, the game starts (step 928). If No, app attempts to load assets from server (step 936). Is load succeeded? (step 940). If Yes, start game (step 928), if No, the app alert the user for next action (step 942). The user should take action (step 938) to go back to step 912 or to cancel and end (step 934).

The present invention further provides a method for using a detachable toy console usable as a control unit in multiple connected toy systems, said method comprising the following steps: a) connecting the toy console interchangeably with at least one smart device; b) attaching the toy console to a console ready toy; c) utilizing sensors and buttons positioned on the console ready toy; d) saving data relating to the utilization of the sensors on the toy console; e) creating an output on the smart device or the toy console relative to the utilization of the sensors on step (c); f) transferring information and data from the console ready toy via the toy console to the smart device thereby creating a corresponding reaction that appears on the smart device's screen; g) detaching the toy console from the console ready toy attached to it; and reattaching the toy console to another console ready toy, to thereby allow a user to use the toy console with multiple console ready toys, said toy console comprising: a MCU; a communication module for establishing connection with at least one smart device; a connector for attaching and detaching the toy console to the console ready toy; sensor; and a power source. The method may further comprising the step of: h) disconnecting the toy console from the smart device and reconnecting to another smart device.

It should be clear that the description of the embodiments and attached figures set above in this specification serves only for a better understanding of the invention, without limiting its scope. It should also be clear that a person skilled in the art, after reading the present specification could make adjustments or amendments to the attached Figures and above described embodiments that would still be covered by the present invention.

1. A detachable toy console usable as a control unit for multiple connected toy systems, said toy console is configured and operable to connect interchangeably with at least one smart device and to be attached to a console ready toy and detached from it, to thereby allow a user to use the toy console with another console ready toy, said toy console comprising:
a MCU;
a communication module for establishing connection with at least one smart device;
an external connector for attaching and detaching the toy console to the console ready toy; and
a power source;
wherein, said toy console is configured to establish connection and communication with the smart device and the console ready toy and further to perform computations of data received by the toy console before sending it to the smart device, or after receiving it from the smart device.

2. (canceled)

3. A detachable toy console according to claim 1, wherein said toy console is configured to connect with another toy console in an on-line and in an off-line mode, and further capable of exchanging toys IDs, activating sensors and saving data.

4. (canceled)

5. A detachable toy console according to claim 1, wherein said console ready toy comprised at least a toy module, sensors, an external connector to the toy console, and optionally a memory chip, wherein upon utilizing the sensors of the console ready toy, the information is transferred via the toy console to the smart device and a corresponding reaction, appears on the smart device's screen.

6. (canceled)

7. A detachable toy console according to claim 5, wherein the toy module content determines the communication mode between the toy console and the console ready toy and the performance abilities of the connected toy system, and wherein said toy module contains input sensors and output sensors allowing the user to interact with the console ready toy via the input sensors and output sensors to create a sound, an image, a LED indication, a mechanical output relay and a buzzer either on the smart device or on the console ready toy itself.

8. (canceled)

9. A detachable toy console according to claim 1, wherein said console ready toy comprises sensors and/or buttons attached to it allowing attachment of detachable toy elements in various shapes and characters to be attached to the console ready toy via said sensors, and data created on the console ready toy is processed by the toy console and displayed by a proprietary app on the smart device.

10. A detachable toy console according to claim 9, wherein data created or obtained by the smart device is delivered via the toy console to the console ready toy to create a signal on the toy, said signal is either one of a LED lightened, a buzz is heard, and a movement created by the toy.

11. (canceled)

12. A detachable toy console according to claim 5, wherein said memory chip is used to install a toy ID and a unique serial number, so when the console ready toy is connected to the toy console, the toy ID and the unique serial number are being transferred to the toy console and from the console to a smart device for launching a relevant toy app, which transfers the toy ID and its unique serial number to a dedicated server in order to authenticate the toy and to instruct the toy console about how to work properly with the specific connected console ready toy.

13. (canceled)

14. A detachable toy console according to claim 1, wherein said toy console is configured to operate as a smart device and upon establishment of connection between the toy console and the console ready toy authentication process is performed and upon recognition, a relevant toy app is lunched to provide the user an interactive playing experience.

15. (canceled)

16. A detachable toy console according to claim 1, further comprising at least one of the following: function buttons, LED indicators, voice command, offline operating mode configured to allow the user an option to play with the toy without being connected to a smart device, remote control features, a tag reader, and a rechargeable battery.

17. A detachable toy console according to claim 1, wherein said toy console further comprises a motion sensor.

18. A detachable toy console according to claim 1, configured to be wearable on the user's hand via attachment to a hand wearable accessory.

19. A wearable toy console usable as a control unit for multiple connected toy systems, said wearable toy console is configured and operable to connect interchangeably with at least one smart device and to be carried by a toy and/or by a wearable accessory on the hand of a user, wherein the wearable toy console is configured to be passed by the user from one toy to another or to the hand wearable accessory so as to allow the usage of the toy console with multiple toys, said toy console comprising:
a MCU;
a communication module for establishing connection with at least one smart device;
a motion sensor configured and operable to allow reading of movements by the smart device; and
a power source.

20. A wearable toy console according to claim 19, wherein said motion sensor in configured to simulate movement of the toy carrying the toy console upon movement of the toy console itself, as the toy movement rides on the toy console movement and interpreted as if the toy is connected to the toy console.

21. A wearable toy console according to claim 20, wherein data obtained from the motion sensor is saved on the toy console and can be used in an offline and online modes.

22. A wearable toy console according to claim 19, wherein the identification of the toy carrying the wearable toy console is established by either one of the following options: a) by selecting the relevant toy from a list or other visual representation of toys on the smart device screen; b) by entering an ID code which appears on the toy or on its packaging to the smart device; c) by introducing the toy to a camera on the smart device and using image recognition techniques; and d) by introducing a QR code or a similar visual code printed on the toy or on its packaging to a camera of the smart device and a software, running on the smart device, uses the camera to take a picture of the visual code, and to analyze the visual code.

23. A wearable toy console according to claim 19, wherein the toy console is inserted into a dedicated pocket or groove on the toy or on the hand wearable accessory.

24. (canceled)

25. (canceled)

26. (canceled)

27. A wearable toy console according to claim 19, wherein the toy is a wearable toy configured to carry within it the toy console.

28. A wearable toy console according to claim 19, wherein the toy console is carried by the hand wearable accessory and the user is playing with a virtual toy selected from the smart device.

29. A wearable toy console according to claim 19 further comprising at least one of the following: function buttons, LED indicators, remote control features, voice command, offline mode, and a rechargeable battery.

30. A detachable toy console usable as a control unit for multiple connected toy systems, said toy console is configured and operable to connect interchangeably with at least one smart device and to be attached to or to be carried by a toy and/or by a wearable accessory on the hand of a user, wherein the detachable toy console is configured to be passed by the user from one toy to another or to the hand wearable accessory so as to allow the usage of the toy console with multiple toys, said toy console comprising:
a MCU;
a communication module for establishing connection with at least one smart device;
connection elements configured to allow reversible attachment of the toy console from to the toy and/or to allow carrying of the detachable toy console by a toy and/or a wearable accessory;
a motion sensor; and
a power source.

31. A method for using a detachable toy console usable as a control unit in multiple connected toy systems, said method comprising:
a. connecting the toy console interchangeably with at least one smart device;
b. attaching the toy console to a console ready toy;
c. utilizing sensors and buttons positioned on the console ready toy;
d. saving data relating to the utilization of the sensors on the toy console;
e. creating an output on the smart device or the toy console relative to the utilization of the sensors on step (c);
f. transferring information and data from the console ready toy via the toy console to the smart device thereby creating a corresponding reaction that appears on the smart device's screen; and
g. detaching the toy console from the console ready toy attached to it; and
reattaching the toy console to another console ready toy;
to thereby allow a user to use the toy console with multiple console ready toys, said toy console comprising: a MCU; a communication module for establishing connection with at least one smart device; a connector for attaching and detaching the toy console to the console ready toy; sensor; and a power source.

32. A method for using a detachable toy console according to claim 31, further comprising the step of:
h. disconnecting the toy console from the smart device and reconnecting to another smart device.

33. A method for using a detachable toy console according to claim 31, wherein said toy console is configured to establish connection and communication with the smart device and the console ready toy and further to perform computations of data received by the toy console before sending it to the smart device, or after receiving it from the smart device, and optionally to connect with another toy console in an on-line and in an off-line mode, and further capable of exchanging toys IDs, activating sensors and saving data.

34. (canceled)
